(19) United States
(12) Patent Application Publication
(10) Pub. No.: US 2004/0113938 A1
(43) Pub. Date: Jun. 17, 2004

(54) An arrangement and a method for presentation customization in a portal structure

(76) Inventor: Jan Akerfeldt, Taby (SE)

Correspondence Address: ERICSSON INC., 6300 LEGACY DRIVE, M/S EVR C11, PLANO, TX, 75024, US

(21) Appl. No.: 10/470,221

(22) PCT Filed: Jan. 24, 2002
(86) PCT No.: PCT/SE02/00122

(30) Foreign Application Priority Data
Jan. 24, 2001 (SE) 0100190-8

(51) Int. Cl. G09G 5/00

(52) U.S. Cl. 345/738

(57) ABSTRACT

The present invention relates to a portal structure providing end user stations with access to services/applications. It comprises a portal core (1) and a number of services/applications (25). The services/applications (25) generate/use a generic markup language, and the portal core (1) comprises a presentation arrangement (11) with reading means (11A) for reading service/application data in the generic markup language received from the services/applications (25), rendering means (15) for translating and rendering the service/application data into another markup language understandable to a requesting end user station (5). It also comprises first storing means (16) for storing at least end user presentation selections relating to presentation characteristics, second storing means (17) for storing presentation characteristics files and presentation control means (18) for controlling/managing the selection and implementation of the appropriate presentation characteristics file(s) for an end user (5) accessing an application/service (25).

### FIELD OF THE INVENTION

The present invention relates to a portal structure providing end user stations with access to services/applications. Particularly it relates to an Internet portal, and specifically it relates to a portal structure allowing presentation customization. The invention also relates to an arrangement in a portal structure for handling presentation of services/applications requested by an end user station, which allows for customization of the presentation to the end user. Still further the invention relates to a method of presenting a service/application, requested by an end user station via a portal structure, to the end user.

### STATE OF THE ART

When referring to a portal is generally meant an Internet portal. There is an increasing need to personalize or customize the way an end user can access services, especially independently of the actual location of the services or applications. At the same time the demand for access to mobile Internet services gains importance, i.e. the end users need to be able to, in a rapid and uncomplicated manner, get access to services from any end user station, i.e. also from mobile devices; it may e.g. relate to sending and receiving e-mails, short messages, accessing web-based information from mobile as well as fixed end user devices, in a user friendly, quick and simple manner. This is called the mobile Internet.

Browsing using a mobile device is more difficult than browsing using a PC, since the mobile device, as compared to the PC, has limited input and output capabilities. Thus, this means that it gets even more difficult to provide mobile end users with a satisfactory personalization and management of services. There is also an increasing demand, on behalf of the end users, to always be able to access applications and services. A portal is such a doorway to the content of services and applications, which particularly should be tailored to suit the end user preferences, e.g. as far as presentation features are concerned.

Examples on portal content are information services (also including push content, which relates to an Internet technique through which all information a user subscribes to automatically is provided to the user, or information that the service provider or operator means that the user should be provided with). Examples on information services are weather forecasts, or weather information in general, commercial services such as shopping malls, or generally any kind of information, multimedia services such as streaming audio/video, games, instant messaging and newsgroups, web based mail, access to particular communities through chat-rooms. Thus it is highly desirable to be able to provide appealing graphical user interfaces for representing applications and menus on PC:s, and particularly also for WAP-enabled devices, in case a portal is mobile. Much effort is also put down on personalizing the structure and the content of personal portals, and to provide a possibility to control the interaction and behaviour of individual services and applications by setting personal preferences. It has however turned out to be difficult to provide for satisfactory access possibilities irrespectively of which kind of device that is used by an end user.

A portal core is the central part of the portal structure that is needed to develop a portal framework, within which content and applications can be disclosed and accessed by end users, in a controlled and unified manner.

Until now many applications are in principle exclusively designed for the 2G telecommunications environment and they have been implemented as monolithical blocks, or with a proprietary service network to handle the specific QoS requirements for the respective applications. This has a consequence that such applications work satisfactorily as isolated applications, but they are difficult to integrate with other applications developed in similar ways. Applications developed for the Internet (Internet protocol) environment have to a large extent been based on established and open de facto standards supporting extensive integration of different applications. Many such standards have been used in the 2G environment for non real-time critical applications. However, through the introduction of 3G networks (3GPP), future applications will contain a mixture of telecommunication and datacommunication services, mixing higher and lower bit rates, as well as real time and non-real time traffic. The service networks of today are not designed to handle such mixtures. The existing IP-based applications are also not designed for the specific characteristics of wireless networks.

In a portal there may be different requirements or demands on the presentation characteristics, the “look and feel”, for different applications, and also depending on which is the actual end user. “Look and feel” in this context generally is concerned with fonts and colours displayed to the user. One way to configure the presentation characteristics, or the “look and feel”, is by using CSS files (Cascading Style Sheets). A CSS file contains formatting information e.g. for HTML-pages. The formatting information may comprise information relating to colours, fonts etc.

XML is described in W3C Recommendation, Oct. 6, 2000, Extensible Markup Language (XML) 1.0, (Second Edition). XSL(T) is described in W3C Recommendation Nov. 16, 1999, XSL Transformation (XSLT) Version 1.0 and W3C Working draft Dec. 12, 2000, XSL Transformations (XSLT) Version 1.1. CSS is described in W3C Recommendation of December 1996, Cascading Style Sheets, level 2 (CSS2). These documents are herewith incorporated herein by reference.

However, different users may want to select their own “look and feel” or presentation characteristics. They may also want to use the same “look and feel” for all services/applications. There may be different CSS files for different applications and for different users. Services or applications producing a generic markup language, particularly XML data, may for instance be unaware of which “look and feel”, or which CSS file, a particular user has selected. Further still, a service or an application might not even know which CSS file the portal owner has selected for different applications.

To make it even more complicated, different CSS files have to be used for different end user stations that an end user may use. Services/applications do not know which particular end user station an end user currently uses since, in a portal structure generating a generic markup language, e.g. XML data, services/applications would produce an output that is independent of the type of end user station.

In the portal core of the portal structure a presentation arrangement is provided, which comprises means for rendering the service/application data in the generic markup language into a format that is understandable to the end user station. Then the situation may be that the service/application does not have any information at all about the end user station, or about the end user himself; in particular the service/application does not know which selection the end user has made, if he has made one, as far as presentation characteristics or “look and feel” are concerned. If such a selection by the end user is supported by a portal structure, such information may be stored in the presentation arrangement. For example there may be one “look and feel” setting for each end user, but still the same CSS file might not be applicable since the end user may use different end user stations. The owner of the portal structure may also have selected presentation characteristics or “look and feel”, particularly on a per service (application) basis. Presentation issues have so far been handled by letting the services/applications produce information about which style sheets, CSS files, to use. This means that each service/application has to perform a look up and produce such information. This is clearly disadvantageous and unflexible, and it is an obstacle to customization.

According to another solution, XSL transformation sheets (for performing the translation or for rendering into the markup language used by the end user station) are provided with hard coded links to CSS files. However, the CSS files are static and they can not change depending on user or end user station. Thus, also in this manner it is not possible to satisfactorily provide for customization, and no flexibility is provided for.

### SUMMARY OF THE INVENTION

What is needed is therefore a portal structure which allows for (user) customization of the presentation characteristics. Particularly a portal structure is needed through which services/applications can produce data, particularly in a generic markup language, independently of any presentation settings, particularly without having to know where presentation characteristics files are located, which these files are, type of end user station and end user selections, and possibly also other types of selections, e.g. portal selections, which means selections made by the portal owner. A portal structure is also needed which does not suffer the drawback of having to rely on static presentation characteristics files which can not be changed depending on end user or end user stations, or by having to use hard coded links to presentation characteristics files by the rendering means performing a translation or transformation to a markup language understandable to the current end user station.

Particularly a portal structure is needed through which it is possible to set the presentation characteristics, or the “look and feel”, for the portal output, based on end user, end user station, and possibly also portal settings or selections.

Still further a portal structure is needed through which an end user can have the same presentation characteristics, or “look and feel”, independently of which end user station he currently uses, such that an end user presentation selection can be the same for all services/applications requested, and independent of end user station. As an alternative an arrangement may also be needed through which an end user can select different presentation characteristics depending on end user station and/or depending on service/application.

Particularly a portal structure is needed through which it is easy to select and implement the appropriate presentation characteristics files, particularly CSS files, for the currently used end user station, and through which maximum flexibility is obtained as far as presentation variety is concerned.

A presentation arrangement in a portal structure through which one or more of the above mentioned objects can be fulfilled is also needed.

Still further a method of presenting services/applications content to an end user is needed through which one or more of the above mentioned objects can be fulfilled. Moreover a portal structure is needed through which it is possible to provide a common “look and feel” irrespectively of where applications/services reside, or by whom they are provided. Generally an arrangement/a portal structure is needed which is capable of giving an end user the maximum freedom and flexibility as far as presentation options are concerned, as well as flexibility for portal owners and application providers and operators.

Further yet a portal structure, an arrangement and a method respectively is needed which is end user friendly and easy to use, and which allows user personalization or customization such as to meet the specific requirements and preferences of different end users.

By using a generic markup language in a portal, content of applications and services can be generated and/or stored independently of user station or user device, and before showing the content of an application or a service, the content can be transformed into the/a format, i.e. the markup language, that can be understood by the end user device. One example on such a generic markup language is the XML (Extended Markup Language). As a standard for navigation in an XML-based portal is the XLink specification used which allows elements to be inserted into XML documents in order to create and describe links between resources. XLink provides a framework for creating both basic unidirectional links and more complex linking structures. It allows XML documents to assert linking relationships among more than two resources, associate metadata with a link and to express links residing in a location separate from the linked resources.

In the following some concepts used in this document will be described or defined. A portal is generally a non-physical entity in the Internet domain which can be described as an “electronic publishing space” which is owned by an individual or an organization, and which provides either direct access to information and services, or links to other entities in the Internet or private intranet domains providing information and services to authorized end users. A portal is in its simplest form a regular home page or a list of links, whereas in more advanced forms it may offer interactive services, not only to those who consume what is published, but also to those who are granted the right by the editor to publish on the portal, as well as to the editor himself, regarding different aspects on how the portal is used.

Wireless end users are given access through a “service” portal. Such a “service” portal is different from a traditional fixed Internet portal for PCs and end users demand personalized services delivered to and presented on their mobile terminal at least as an option. In this document reference is made to a portal structure. A portal structure can here be a “service portal” or a conventional (Internet) portal.

An application comprises one or several cooperating software entities, the functional focus being user interaction and usefulness for the end user. An application platform is a defined combination of software and hardware entities used to implement applications of a certain kind which are characterized by the functionality and quality of its constituent parts.

By portal infrastructure is, in general terms, meant the software and hardware entities needed to either host or produce or generate a specific portal. Specifically it contains a portal core, an IP infrastructure and service enabling means, also called service enablers.

A service enabler is a support functionality accessed via APIs (Application Programming Interface) raising the abstraction level and simplifying the task of the application developers. A portal core is the core of a portal infrastructure. By a service network is generally meant an IP-based network which consists of nodes hosting application servers, service capability servers, application support servers, IP infrastructure servers etc. Application support servers interface with service network resources or other external resources than core networks, whereas service capability servers interface with resources and functionality in core networks.

In the present application a portal structure is intended to mean a portal core, a plurality of services and applications with their content and service enabling means (service enablers). Generally may also the connectivity and data bearer functionality be seen as included in the portal structure.

Therefore, in order to meet one or more of the objects referred to above, a portal structure providing end user stations with access to services/applications is provided. It particularly comprises a portal core, (service enabling means), connectivity means via which end user station access is provided and a number of services/applications. Although the services/applications are expressed as being comprised by the portal structure, it should be clear that they may either be internal, i.e. provided by the portal structure, or external, i.e. provided by external service or application (content) providers.

It is particularly supposed that the services/applications generate or use a generic markup language. The portal core comprises a presentation arrangement with reading means (a request broker) for reading service/application data in the generic markup language received from the services/applications, rendering means for translating and rendering the service/application data into another markup language understandable by a requesting end user station, first storing means for storing at least end user presentation selections relating to presentation characteristics, second storing means for storing presentation characteristics files, and presentation control means for controlling/managing selection and implementation of the appropriate presentation characteristics file(s) for an end user accessing an application/service based on presentation selection(s) and end user station.

In a particular implementation, at least for some services/applications portal presentation selections are also provided. The portal selections may be stored separately or in said first or second storing means. It may also be the case that for some services/applications and/or for some end users, no end user presentation selections are available. Still further end user presentation selections and portal presentation selections may relate to different characteristics, but they may also relate to the same characteristics. Still further for some services/applications, application/service presentation selections are provided containing information relating to which presentation characteristics files that are to be used. Also in this case the application/service presentation selections may relate to one or more characteristics for one or more applications/services.

Although it here specifically refers to three types of presentation selections (end user, portal, application) it should be clear that other types of presentation selections may be provided, in addition to the above mentioned types of selections, or instead of one or more of said types of selections. There may e.g. be different selections for different times, e.g. one for 9 a.m. and one for 6 p.m. etc. Different selections of any kind may be provided, the functioning according to the invention will be the same.

Particularly an end user presentation selection, if available, has priority over a portal presentation selection as well as over an application presentation selection whereas an application presentation selection may have priority over a portal presentation selection. The case may be that for some characteristic(s) the end user selection will be used, whereas for another characteristic the application selection will be used (if for such a particular characteristic there is no end user presentation selection) etc. A presentation selection, if made by an end user, the portal owner or by an application, may sometimes relate to some (but not all) characteristics. Thus, in one embodiment, for characteristics for which there are no end user presentation selections available, the application presentation selection is used, and if there is no application selection, the portal selection will be used. For characteristics where there are more than one selection (of type end user, portal, application) the end user selection overrides the others, whereas the application selection overrides the portal selection. Of course also other priority alternatives are possible. By a selection (of a given type) is meant a presentation selection (of the given type).

Particularly an end user presentation selection can be updated by the end user through giving in a new end user presentation selection. The presentation selection particularly is a selection relating to “look and feel”, i.e. colours, fonts etc.

In a particularly advantageous implementation the presentation characteristics files comprise so called CSS files (Cascading Style Sheets). The control means particularly establishes which are the presentation characteristics files and the locations thereof, i.e. the addresses, based on end user/portal selection in combination with currently used end user station. In a most advantageous implementation location information relating to the, by the control means, established characteristics files is introduced as metalink tags, (metalocation information tags) to the generic service/application data.

The rendering means of the presentation arrangement translates and renders the generic application/service data including links to the appropriate presentation characteristics files as determined by the control means, and for each characteristic, the presentation selection alternative (e.g. end user/application/ portal) having the highest priority is used.

In preferred embodiments the generic markup language generated by the services/applications is XML.

Particularly the location/address information relating to the location of the presentation characteristics files (CSS files) is given by the end user/portal/application selections, and the current end user station type is added to the service/application data subsequently to having been received and read by the presentation arrangement, but before the rendering procedure has been initiated.

To determine the appropriate CSS files that are to be used, or, more generally, the presentation characteristics files, the control means, based on end user presentation selection and/or portal and/or application presentation selection, and depending on which selections are available, determines a number of e.g. CSS files, and for each such CSS file a metalink tag relating to the location of the corresponding CSS file is inserted into the application XML data. Subsequently the XML data is translated into the end user station markup language including the CSS link(s) having the highest priority for the respective characteristics.

The invention also provides a presentation arrangement in a portal structure for handling presentation of services/applications requested by an end user station. The presentation arrangement comprises a rendering means for rendering service/application data provided from requested services/applications for presentation on an end user station. The presentation arrangement comprises reading means (e.g. a request broker) for reading service/application data received in a generic markup language from a service/application, second storing means for storing presentation characteristics files, first storing means for storing end user presentation selections relating to presentation characteristics, and control means for controlling/managing the selection and implementation of the appropriate presentation characteristics file(s) for presentation of a requested service/application on an end user station.

Particularly, at least for some services/applications, portal and/or service/application presentation selections are provided (or any other types of selections, in addition thereto, or as alternatives). A presentation selection, e.g. an end user selection, a portal selection or a service/application selection, may refer to one or more characteristics, in other words, a user selection may either relate to all presentation characteristics needed for presentation on the end user station, or it may relate to only one or a limited number of characteristic features. Preferably an end user presentation selection, if available, is given a higher priority than a portal service/application selection.

An end user presentation selection may be made for all services/applications but it may also be made on a per service/application basis or in any other appropriate manner. Advantageously the presentation characteristics files comprise CSS (Cascading Style Sheets) files. The presentation control means, briefly the control means, may particularly be used to establish which the relevant presentation characteristics files are based on end user presentation selection and end user station type, and/or portal presentation selection and end user station type, and/or application/service presentation selection and end user station type.

In a most preferred implementation location information data relating to the relevant presentation characteristics file(s) (CSS files) is introduced into the service/application data in the generic markup language as metalink tags before the service/application data is rendered by the rendering means. Particularly the generic markup language is XML and the rendering translates service/application XML data into the/a markup language understandable to a requesting end user station and inserts links to the appropriate presentation characteristics file(s)/CSS files. When the rendering operation takes place, the priorities of the respective presentation selection types are taken into account.

The invention also discloses a method of representing a service/application requested by an end user station via a portal structure. The method comprises the steps of; storing at least end user presentation selections in first storing means; storing a number of presentation characteristics files in second storing means; receiving and reading data in a generic markup language from the requested service/application; controlling selection and mapping of presentation characteristics file(s) depending on end user presentation selection and/or portal presentation selection and/or application presentation selection in combination with current end user station type; introducing a reference to the presentation characteristics file(s) into the service/application data in the generic markup language; rendering the data in the generic markup language by translating it to the/a markup language understandable to the end user station including a number of links to the relevant selected presentation characteristics files.

Preferably the generic markup language is XML and the presentation characteristics files comprise CSS files.

Particularly the method includes the steps of; introducing references in the form of metalink tags into the XML data; performing the rendering step by means of an XSL transformation sheet selected in dependence of the type of the current end user station; inserting the appropriate CSS-link(s) into the produced markup language. Still further the method may include the steps of; using end user presentation selections, e.g. portal presentation selections and e.g. application presentation selections in combination with information on the type of the current end user station to point out a number of CSS files; and, in the rendering procedure, for each presentation characteristic using the type of presentation selection (end user, portal or application) having the highest priority for rendering with the output data into the output markup language understandable to the end user station, whereby an end user presentation selection has the highest priority, an application presentation selection the second highest priority etc.

In a particularly advantageous implementation is also provided for continuous navigation as described in the copending patent application “An arrangement and a method relating to access of application/services” which is a Swedish Patent Application filed by the same applicant and on the same date as the present application and the content of which herewith is incorporated herein by reference. According to this patent application metalink tags are introduced or generated by the services/applications and the presentation arrangement further comprises means for replacing such metalinks, when received, with real addresses of the services/applications referred to by the metalink tags. It should be noticed the difference to the meta (presentation) link tags according to the present invention which are not introduced by the services/applications but by the presentation arrangement, i.e. by the portal, subsequent to receiving service/application data but before rendering or translating the data.

In such an advantageous implementation is provided for continuous navigation irrespectively of where services/applications (content) are located, at the same time as a customized presentation on user stations is enabled.

The portal structure with the portal core comprising the presentation arrangement, in addition to the presentation arrangement, among others comprises session handling means for user session management. In “An arrangement and a method relating to session management in a portal structure” unified session management is described. Also this patent application was filed on the same date by the same applicant as the present application and also the content thereof is herewith incorporated herein by reference. In a most advantageous implementation the portal structure in addition to enabling customized presentation (and continuous navigation) may also provide for unified session management.

In a most advantageous embodiment the portal structure is mobile, i.e. it supports access by mobile end user stations over a mobile communication network, such as for example GSM (Global System for Mobile communications), GPRS (GSM General Packet Radio Service), UMTS (Universal Mobile Telecommunications System), Bluetooth (which is a short range radio technology), WAP (Wireless Application Protocol) etc. Advantageously the portal structure supports access by broadband devices such as PCs, using a browser, as well as mobile devices, such as WAP-devices.

In other terms the portal structure supports access by fixed as well as mobile end users stations using different access formats, or using different markup languages for communication with the portal structure.

Although the invention is not limited thereto, the generic markup language used by, or generated by, the services/applications and the portal core, may be XML. The XML-data and the metalinks are defined in a Document Type Definition language (DTD) and a metalink tag in XML-data comprises information about metalink type, a reference and addressing attribute (URL) containing service/application location information. DTD is e.g. an XML-document describing all the elements and their attributes which are allowed in all the documents belonging to the particular DTD. The translating means (of the rendering means) translates XML-data by performing a transformation (XSL), i.e. the XML-data is processed with a transformation stylesheet (XSL transformation) to produce an output format, i.e. a markup language, appropriate for the accessing end user station, e.g. HTML for a fixed end user station and WML for a mobile end user station. The presentation characteristics files, e.g. the CSS files are here seen as applications.

### BRIEF DESCRIPTION OF THE DRAWINGS

The invention will in the following be further described in a non-limiting manner and with reference to the accompanying drawings in which:

FIG. 1 schematically illustrates an overview of one portal structure in which the inventive concept can be implemented,

FIG. 2 illustrates a conceptual division of the presentation arrangement (layer) of the portal structure of FIG. 1 into a rendering functional layer and a service functional layer,

FIG. 3 schematically illustrates a portal core with a presentation arrangement according to the invention and an end user station requesting an application,

FIG. 4 is a schematical flow diagram illustrating the inventive procedure when an end user accesses an application,

FIG. 5 is a flow diagram describing a specific implementation in which XML is used as the generic markup language and the presentation characteristics files comprise CSS files, and

FIG. 6 is a flow diagram giving one example on the procedure when different presentation selections have been given and how a priority scheme may be implemented.

### DETAILED DESCRIPTION OF THE INVENTION

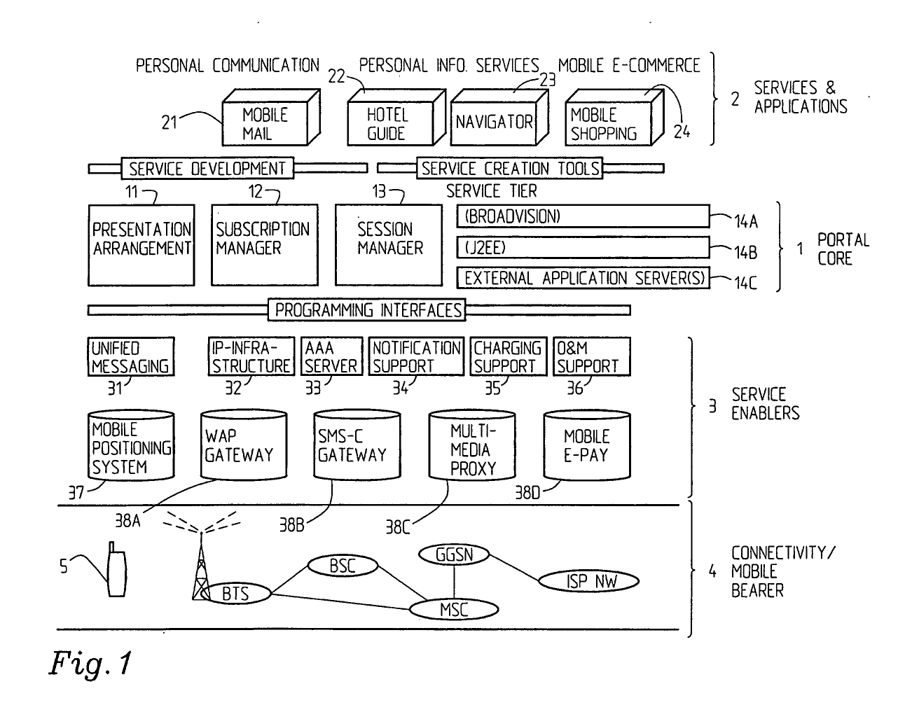

FIG. 1 shows one example on a portal structure 10 in which the inventive concept can be implemented. The portal structure 10 comprises a portal core 1 handling presentation functionalities, subscription and session management functionalities, a number of services and applications 2, comprising for example personal communication services, personal information services and Mobile E-Commerce services. It does not matter which kind of services that are provided, the inventive concept is applicable to any kind of service, content and application. When explaining the inventive concept in a more detailed manner, when an end user requests access to a service or an application, any service or application (or content) is meant and can be seen as conceptually included in the portal structure, although some of the services and applications actually are located outside the portal structure and are provided by any external service provider.

The portal core structure 1 further includes a layer 3 including a number of service enabling means or service enablers 31-37, 38A-38D. The service enablers among other things are involved in authentication and basic services, such as gateways and IP infrastructure. In this figure some examples on service enablers are given, such as unified messaging 31, IP infrastructure 32, notification support 34, charging support 35 and operation and maintenance support 36. Further examples of service enablers are mobile positioning system 37, WAP gateway 38A, SMS- C gateway 38B, multimedia proxy 38C, mobile E-pay 38D etc. It should be clear that some of these service enablers are more or less mandatory, whereas others are optional.

The portal structure is here also seen as including a connectivity or a (mobile) bearer layer comprising the mobile base stations and switching nodes, such as BTS (Base Transceiver Station), BSC (Base Station Controller), MSC (Mobile Switching Center) nodes etc. Which the nodes are, depends on which mobile network access is provided over, e.g. GSM. For GPRS or UMTS corresponding nodes are included in this layer; for example GGSN (Gateway GPRS Support Node). Whichever is the network, the network is the data bearer for the portal for access of mobile devices such as WAP-devices (Wireless Application Protocol). In FIG. 1 it is supposed that the accessing end user station comprises a WAP-telephone 5.

One example of such a portal structure is the Ericsson WISE™ Portal.

Examples of services and applications are mobile mail 21, hotel guide 22, navigation 23 and mobile shopping 24. Internal applications or services can be seen as applications leveraging the service enablers and connectivity layers to add application specific values to mobile Internet applications of various categories, for example mobile services, personal communications, such as unified messaging or mail services, and personal information services. The information may be retrieved by the user through searches, but the information may also be provided to the end user by means of the push technology. This is open to end user customization.

It is here supposed that the portal supports access by mobile end user stations, such as WAP-telephones 5 over a mobile network. Therefore nodes or components of the relevant mobile network have to be provided in the mobile network connectivity and data bearer layer. In FIG. 1 a component denoted ISP network, Internet Service Provider network, is disclosed. This is an optional component.

Some of the. service enablers are seen as important components for providing mobile Internet functionalities. Some of the service enablers are seen as one part of the interface components between Internet and the mobile network. One component is here denoted IP infrastructure 32. An optional service enabler comprises the notification support 34, which generally is an optional component enabling applications to send out filtered notifications to end users using the SMS (Short Message Service) channel, but it may also be adapted to include other channels supporting WAP technology and 3G (3GPP) technology. Charging support enabler 35 may be provided to allow for flexibly choosing charging events. Another service enabler 36 relates to operation and maintenance support and generally it is a mandatory component. A service enabler WAP gateway 38A is an optional service enabler WAP gateway/proxy forming the access point between the wireless world and the Internet world. It supports mobile clients accessing the WAP gateway/proxy using GSM circuit switched data or WAP over SMS (SMS over MAP (Mobile Application Protocol)). The client uses a WAP enabled browser in the mobile device to connect to the WEB-server where the desired WAP application resides. Another service enabler, mobile positioning system, 37 is an optional component allowing sending the position of a user to the application requesting it. Another service enabler is a multimedia proxy 38C responsible for transmitting multimedia data over GPRS or UMTS. This however is an optional service enabling means. Also SMS-C (center) 38B is an optional component responsible for sending or receiving, storing and forwarding short messages between mobile stations and servers. Proprietary protocols are used for communication with applications. Mobile E-pay 38D is a component offering the basic functionality for Mobile E-Commerce and it is an optional component. Finally, AAA-Server is a service enabling component relating to authentication, authorization and accounting. These functionalities may be provided in other manners but they may also be integrated in a functionality server for example enabling traffic based charging and period based charging. Such a component, either if it is split up into different components, or if it consists of one component which is common for a number of functionalities, is mandatory.

However, it should be clear that Fig. 1 merely shows examples on service enabling means that may be provided in a service enabling layer 3. At least some of the illustrated service enablers may be excluded, still others may be included etc.

The portal core, or the portal core layer, handles, as referred to above, presentation, subscription and session management and service tiers comprising a number of internal (and external) application servers. The core 1 comprises a presentation arrangement 11 which enables mobile portal presentation on multiple devices using multiple protocols. It may e.g. be XML driven (or more generally driven by a generic markup language). In one implementation it is a Java™ and XML driven multimarkup language capable presentation module.

The presentation arrangement 11 comprises a rendering means (a rendering engine) which in one implementation uses XML/XSLT technologies to ensure that information presented by services within the portal can be displayed in a standardized way regardless of which end user station an end user uses when accessing the portal structure. Through the use of a generic markup language, for example XML/XSLT, the portal will be able to, as will be more thoroughly discussed below, offer a unified “look and feel” of content presented within the portal presentation space, i.e. it may e.g. ensure that the use of for example colours, fonts and background images are enforced for all services displaying their information through the portal, if desirable.

The functionalities within the portal core 1 and of the presentation arrangement 11 in particular will be further described below.

The portal core 1 also includes a subscription manager. In one implementation subscription manager component information is stored in an LDAP (Lightweight Directory Access Protocol) directory and it is managed by a service called a subscription manager. A subscription manager includes functions for the operator to create, maintain and delete subscriber information in the subscriber database. It also enables the end user of the system to subscribe to the services in the system. In a particular implementation a self-registration and self-service concept is supported in order to minimize costs by minimizing the workload on a customer care center. Information about available services may also be kept in the directory referred to above and handled by the subscription manager. As a new service is entered to the directory, it will immediately be available for subscription by the end users. In the directory end users can be grouped so as to make new services available only to defined sets of end users. The subscription manager 12 can be interfaced with an existing customer care system through the Application Programming Interface (API) it uses.

The session manager 13 is a general mechanism that can be used by applications and services. It comprises an interface to a subsystem for keeping track of all visitors to the portal and to provide the profile information of the visitors. When an end user enters the system/application, a session-id entity is allocated and it is stored for that particular end user until logging out of the service or when the end user has been idle for a preset period of time. When a participating application starts, it first checks if there is an active session-id for a particular user and if there is, it would be able to resume from where the session was broken.

Finally the portal core structure 1 here comprises two “internal” application servers 14A, 14B and one or more external application server 14C. The external application server 14C contains links to external application servers running existing services. In one implementation the service tier comprises three classes of services, of which the first class is developed in compliance with the portal core specifications implemented using the portal core environment. The second service class relates to services which not necessarily are implemented in the portal core environment such as for example an external e-mail system running on a non-portal core environment adapted to present itself through the portal core presentation. The third service class relates to external services which do not comply with the portal core service development or presentation architectures.

One embodiment of the invention will be described with reference to FIG. 3, which shows an implementation in which it is supposed that the portal structure supports access by mobile as well as fixed end user stations.

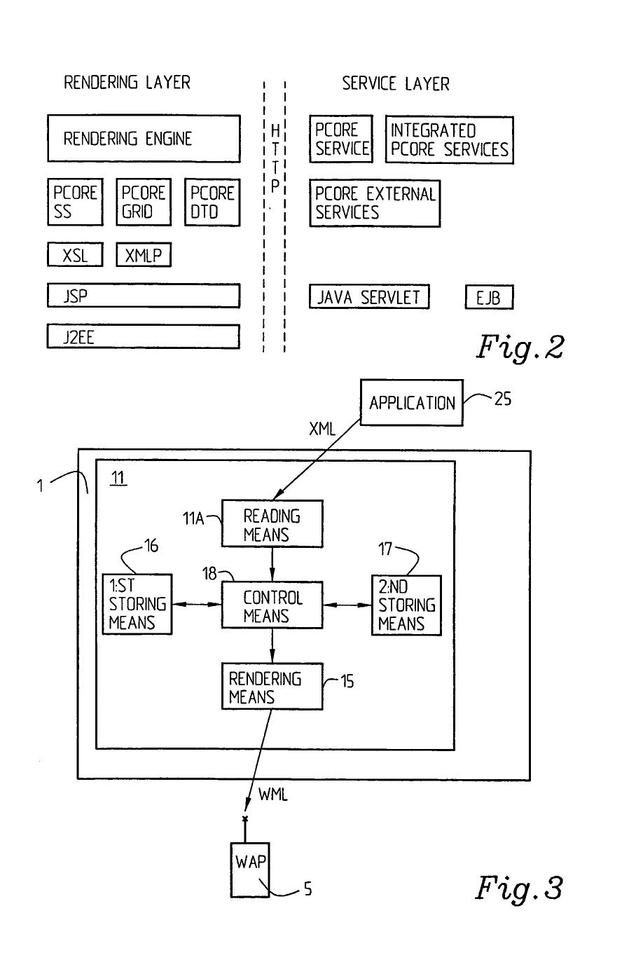

However, first the portal core, and specifically the presentation arrangement, or the presentation layer, will be more thoroughly described, particularly with reference to FIG. 2. The service tier, cf. FIG. 1, in one advantageous implementation comprises three service classes. The service class portal core service (pcoreservice) complies with the specifications of the portal core and it is used to leverage the portal core characteristics. In one implementation the services are implemented using the J2EE IBM WEBSphere Environment (an application server used to develop programmatic services involving logic, algorithms etc.). Such services generally have three or four tier architectures deploying JSP (Java Server Pages) on the front end, Java servlets and Enterprise Java Beans in the middle layer and various entities on the back end. The second service class are the integrated portal core services (integrated pcore services) which leverage pcore presentation services but which are not necessarily implemented in the portal core J2EE environment, e.g. an external e-mail system running on a non-portal core environment but adapted to present itself through the portal core presentation. The third service class, pcore external services, neither complies with the portal core service development nor with the presentation architectures but the services have to be triggered to, or brokered by, the portal core.

In one implementation there are two types of service options available within the service layer. One may consist of services provided by Broadvision (CORBA; for creating optimized rule based and personalized services connected to commerce and retail), and optimized for content delivery by a matching engine operating on content, profile and business rules. The other service type relates to programmatic services, for example requiring algorithms, logic etc. which are not easily built in an optimized content delivery system. If these services are of pcore service class, then they may be industrialized for IBM WEBSphere J2EE environment and if they are of integrated services class and running in an external service server, they are adapted to the portal core presentation.

A service needs specifications including elements on the rendering functionality of the presentation layer as well as relating to the service layer functionality, i.e. schemes and logic. The portal core presentation architecture may, as referred to above, in one advantageous embodiment implement the J2EE architecture for the mechanisms of creating and employing services in specific elements or for defining services. However, the invention is not limited to a portal structure using J2EE and Broadvision; these are merely examples.

The presentation layer is conceptually split-up into two tiers, one rendering layer residing in the portal core itself and a service layer available to any service that wants to present its content through the portal core presentation structure. The rendering layer in one advantageous implementation uses XML/XSLT technologies. Thereby it is also ensured that information presented by services within the portal can be displayed in a standardized way irrespectively of which is the end user station, i.e. irrespectively of which kind of end user station the end user currently uses when accessing the portal. Through the use of XML/XSLT or another generic markup language, a unified “look and feel” of content may be presented within the presentation space as will be further described below.

If XML is used as a generic markup language, a service produces an output in the form of an XML document formatted using structure information from a pcore DTD. The XML document that is output from the service is then used to feed reading means (request broker) of the presentation arrangement. The presentation engine uses pcore SS and pcore grid information associated with the pcore DTD of the XML document supplied by the service to generate the desired interface. Services which do not produce XML from a pcore DTD are particularly also able to present themselves through the presentation services.

As referred to earlier the portal structure is advantageously able to handle different devices such as WAP-phones and broadband devices such as e.g. browsers used by PCs. A portal core structure platform and the logic in it are particularly totally separated from the presentation layer functionality, which makes it very easy to implement support for all different types of clients, even voice and speech synthesizers. By using for example XML/XSL, it is very easy to implement support for instance for a new type of WAP-display size. It is also possible to adapt the rendering process to various WEB-devices, existing and future hand-held devices, voice browsing and interactive TV.

According to the present invention the presentation characteristics, particularly the “look and feel”, for the portal output can be set based on end user, end user station and portal/application settings. References to the appropriate presentation characteristics files are looked up by the presentation control means within the presentation arrangement, depending on end user selections and current end user station (correspondingly for e.g. portal and application presentation selections, if such are available). References to the respective looked up presentation characteristics files are inserted as metalinks tags into the application data in the generic markup language before the generic markup language is further processed. Different presentation selections (of any type) may be applicable at different times, at different occasions, or as determined by any criteria.

The portal core 1 with presentation arrangement 11 is schematically illustrated in FIG. 3. It should be noted that only the means relevant for the functioning of the present invention in the portal core and in the presentation arrangement respectively are shown in this figure for reasons of clarity. It is here supposed that an application 25 is requested by an end user station, here a WAP-telephone 5. The input of the request is not illustrated in this figure and it is supposed that the application, when it starts to run, generates XML data which is input to the presentation arrangement 11 and received in reading means 11A. The presentation control means 18 checks to see if there is an end user presentation selection available and, if yes, fetches or reads the end user presentation selection from the first storing means, e.g. a user database 16. The reading means 11A and the control means 18 may also be comprised by a request broker.

It is supposed that the presentation control means 18 knows which is the type of the requesting end user station. How detection of the type of a current end user station can be performed, is further described in the copending patent application “An arrangement and method relating to end user station access of a portal” which is a Swedish patent application filed on same date as the present application by the same applicant and the content of which herewith is incorporated herein. It should however be clear that, for the purposes of the present invention, information about the current end user station type can be provided in any manner.

Thus, using said information on device and the end user presentation selection as found in the first storing means 16, a mapping is done onto the appropriate presentation characteristics file in second storing means 17. The second storing means may be actual storing means but it may also be seen as a conceptual storing means containing all available presentation characteristics files. Via the presentation control means 18 the address to the appropriate presentation characteristics files can be found. If also portal presentation selections are available, the procedure will be the same. Information about portal selection can be provided in said first storing means or in any other manner, and the control means 18 performs the mapping based on the type of the end user station.

This also accounts for any application presentation selections, for which the mapping likewise is done taking the type of the end user station into account.

Thus one or more metalink tags, containing location information relating to the presentation characteristics files are introduced into the application XML data by the control means 18, or by the presentation engine, i.e. not by the applications. This means that the application 25 can produce XML data independently of any portal and end user “look and feel” selections etc. The applications do not need to know anything about the portal or end user presentation selections. The “look and feel” settings, or the presentation characteristics files, particularly CSS files, will be provided by the presentation engine, or rather by the control means 18.

Rendering means are used to render the application XML data by using an XSL transform sheet. During such a process the XSL transform sheets may be used to produce links in the resulting markup language by pointing out one or more CSS files, or more generally presentation characteristics files. However, it is a problem that the XSL transform sheets are static and do not know where to point the CSS files or the presentation characteristics files to. This means that such location information would have to be supplied by the applications which is disadvantageous.

Therefore, according to the invention, the location information, i.e. the metalink tags are inserted after the XML data from the application has been read in the reading means 11A, but before the data is rendered by the XSL transformation sheets in the rendering means 15. The location information is thus inserted as metalink tags, particularly denoted, in case CSS files are used, metacss tags, into the XML document by the portal. One or more such metalink (metacss) tags can be inserted into the XML document. The rendering means 15 then renders the XML data and inserts the links to the relevant presentation characteristics files into the output data in the markup language understandable to the requesting end user station 5, i.e. in this case WML. If there are more than one metalink tag relating to presentation characteristics files, a priority scheme is used during the rendering process.

If XML is used as a generic markup language and if Cascading Style Sheets CSS are used as presentation characteristics files, the format of a metacss tag inside the XML document may be as follows:

<metacss ref=“url to css file” />

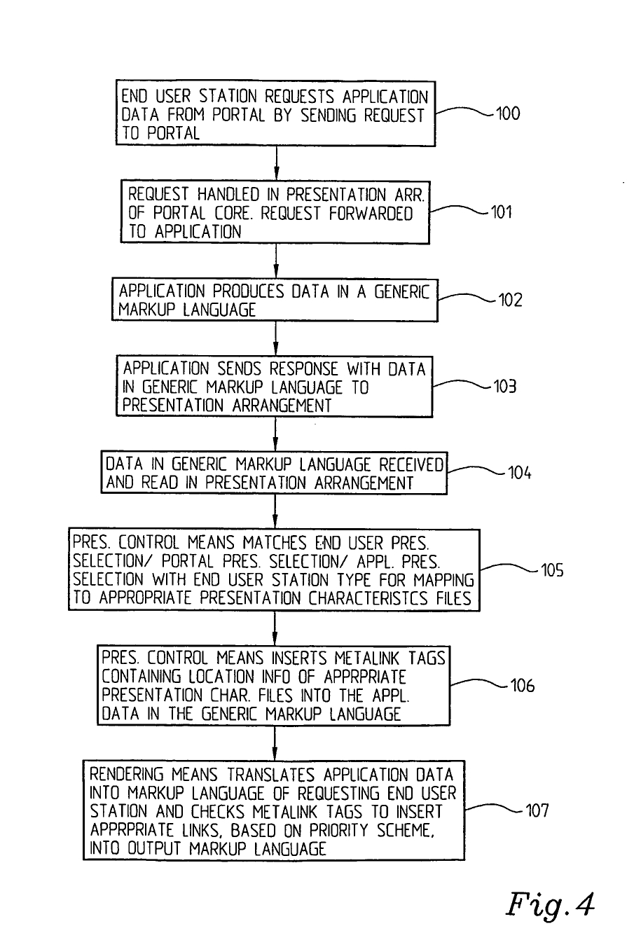

In the flow diagram of FIG. 4 a procedure is disclosed starting with an end user station requesting application data from a portal by sending a request to the portal, 100. The request is handled in the presentation arrangement of the portal core and forwarded to the application, 101. The application starts to run and generates data in a generic markup language, 102. Subsequently the application sends a response with data in the generic markup language to the presentation arrangement, 103. (It should be clear that the data may include metalink tags to other applications, services etc. as referred to in the patent application “Arrangement and method relating to access of applications/services” as referred to earlier. However, how this is done is not relevant for the functioning of the present information and such a functionality may be included or not.)

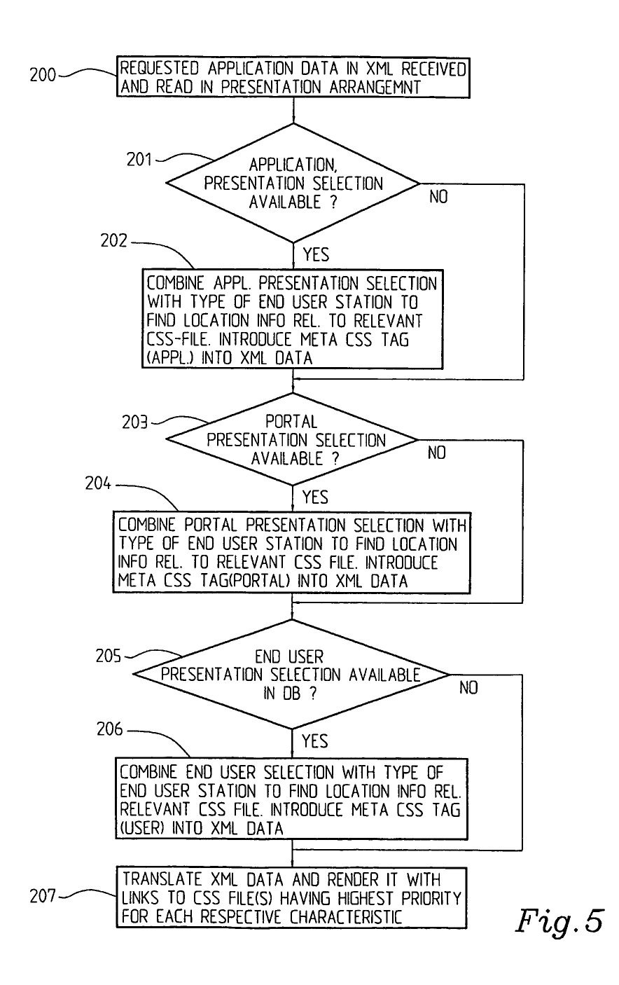

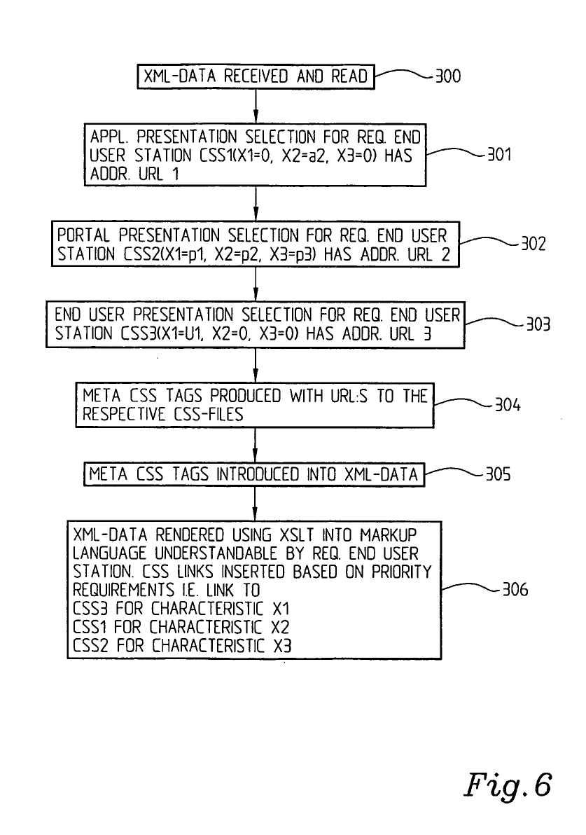

The data expressed in the generic markup language is thus received and read in the presentation arrangement, 104. Generally the application data in the generic markup language is device independent, i.e. independent of the current end user station, and generally does not include any presentation (style) information. The presentation control means then matches end user presentation selection and/or portal presentation selection and/or application presentation selection, depending on which selections are available, with the type of the current end user station for mapping the respective selections onto the appropriate presentation characteristics files, 105. At least the end user presentation selections may be found in a first storing means or an end user database. Also portal presentation selections may be provided in the same database or in another database or in any appropriate manner. The presentation control means then inserts metalink tags, containing location information of the appropriate presentation characteristics files into the application data in the generic markup language, 106. Subsequently the rendering means translates application data into the markup language of the requesting end user station and checks the metalink tags to insert the appropriate links to the appropriate presentation characteristics files, based on a given priority scheme, into the output markup language, 107. Preferably the priority scheme gives the highest priority to end user selections, the second highest priority to application selections and the lowest priority to portal presentation selections. The different types of selections may however also be given other priorities. It should also be clear that a presentation characteristics file or a selection may contain information about different characteristics such as colours and fonts etc. An end user selection does not have to contain a selection of every characteristic, i.e. an end user selection may relate to e.g. only the colour but be silent as to the fonts. Also a portal selection or an application selection may relate to only one or two or any number of the different characteristics. This will be further explained with reference to FIG. 6. FIG. 5 is flow diagram describing the procedure when an application generates XML data and CSS files are used as presentation characteristics files. It is supposed that requested application data in XML is received and read in the presentation arrangement of a portal core, 200. Then it is established if any application presentation selection is available, 201. If yes, the application presentation selection is combined with the type of the end user station, to find location information relating to the relevant CSS file, and a metacss tag (application) is introduced into the XML data, 202. It is also established if there is any portal presentation selection available, 203. If yes, the portal presentation selection is combined with the type of the end user station to find the location information relating to the relevant CSS file and a metacss tag (portal) is introduced into the XML data, 204. Subsequently it is examined if there is any end user presentation selection available for example in an end user database, 205. If yes, the end user presentation selection is combined with the type of the current end user station to find the location information relating to the relevant CSS file, and a metacss tag (user) is introduced into the XML data, 206. It should be clear that the checks for different types of presentation selections can be done simultaneously or in any order. It should also be clear that the inventive concept likewise is applicable to other types of presentation selections, or to different subgroups of the same type of selection, e.g. portal, end user, application.

Subsequently the XML data is translated and rendered with links to the CSS files having the highest priority for each respective characteristic, 207. Particularly the rendering means renders the XML data with the XSLT file which checks the metacss tags to insert CSS links into the produced output markup language. For instance, when producing HTML, “link” tags will be inserted in the HTML header pointing to the CSS files. This relates to output to a browser. In case of WAP device is used, the WML (Wireless Markup Language) is used instead of HTML (Hyper Text Markup Language).

In the following an example will be given supposing that an application produces the following simple XML:

<helloapplication>

<hello name=“Jan” />

</helloapplication>

This data will be received by the presentation engine which will look up the user's “look and feel” settings and then combine them with the current end user station to get the appropriate CSS to be used. This CSS is then inserted into the XML data, for example as:

<helloapplication>

<hello name=“Jan” />
<metacss ref=“/data/css/user_stylel_ie.css” />

</helloapplication>

The same is done for the application CSS in combination with the type of the end user station. The XML data is then processed by the rendering engine which transforms XML data into a markup language that is understandable to the current end user station. This is preferably done with an XSL transformation sheet. The XSL sheet is also selected based on the device, i.e. on the current end user station type. When the data is rendered, the result might be as follows, if the end user example uses an Internet Explorer HTML browser:

<html>
<head>

<link href=/data/css/user_stylel_ie.css type=text/css>

</head>
<body>
Hello there Jan!
</body>
</html>

In the flow diagram of FIG. 6 is very schematically illustrated a procedure when different types of selections are available, each of which relating to one or more characteristics.

Again it is supposed that XML data is received and read in a presentation arrangement, 300. It is further supposed that an application type presentation selection for the requesting end user station has been mapped onto CSS 1 and that there has been no input for a first characteristic X1, a selection a2 has been done for characteristic X2 and no selection has been done for a third characteristic X3. CSS 1 is supposed to have the address URL 1, 301. A portal presentation selection for the requesting end user station mapped onto CSS 2 has been found to have the address URL 2. For characteristic X1 selection p1 has been done, for selection X2 selection p2 has been done and for characteristic X3 selection p3 has been done, 302. The end user presentation selection has been matched with the type of the requesting end user station, resulting in CSS 3 with address URL 3. The end user has done a selection relating to feature X1=U1, has been silent as to characteristic X2 and to characteristic X3, 303. Then metacss tags are produced with the URLs to the respective CSS files (CSS 1, CSS 2, CSS 3 with URL 1, URL 2 and URL 3 respectively), 304. The above metacss tags are then introduced into the XML data, 305. Finally the XML data is rendered using an XSLT sheet (which XSLT sheet that is used depends on the type of the end user station) into the markup language understandable to the requesting end user station. CSS links are inserted based on the priority requirements, i.e. if the priority scheme gives the end user presentation selection the highest priority, the application selection the second highest priority and the portal presentation selection the lowest priority, then a link to CSS 3 will be used for characteristic X1, a link to CSS 1 will be used for characteristic X2 and a link to CSS 2 for characteristic X3.

It is an advantage of the invention that the applications can produce an output in a generic markup language independently of any presentation settings. All presentation information is stored inside the presentation arrangement and different users can have different “look and feel” settings. The correct CSS file(s) can be selected based on the currently used end user station such as to always produce the same “look and feel” for all applications. Alternatively different “look and feel” can be provided for different applications or e.g. at different times etc.; any variation is in principle possible due to the flexibility of the inventive concept; as an example the portal owner can also set different “look and feel” for the different applications or according to any criteria.

It should be clear that the invention can be varied in a number of ways and that it is not limited to the particularly illustrated embodiments.

1. A portal structure providing end user stations with access to services/applications, comprising a portal core connectivity means via which end user station access is provided and a number of services/applications, characterized in that the services/applications generate/use a generic markup language, that the portal core comprises a presentation arrangement with reading means for reading service/application data in the generic markup language received from the services/applications, rendering means for translating and rendering the service/application data into another markup language understandable by a requesting end user station, and first storing means for storing at least end user presentation selections relating to presentation characteristics, second storing means for storing presentation characteristics files and presentation control means for controlling/managing the selection and implementation of the appropriate presentation characteristics file(s) for an end user accessing an application/service.

2. A portal structure according to claim 1, characterized in that for at least some services/applications portal presentation selections are provided and stored separately or in said first storing means.

3. A portal structure according to claim 1 or 2, characterized in that at least some services/applications provide application/service presentation selections.

4. A portal structure according to claim 2 or 3, characterized in that an end user presentation selection, if available, has priority over a portal selection.

5. A portal structure according to claim 3, characterized in that an end user selection has priority over an application selection and in that an application selection, if available, has priority over a portal selection.

6. A portal structure according to any one of the preceding claims, characterized in that one and the same end user selection is valid for all services/applications accessed by the end user.

7. A portal structure according to any one of claims 1-5, characterized in that an end user selection comprises different selection alternatives for different applications/services.

8. A portal structure according to claim 6 or 7, characterized in that an end user selection can be updated by the end user.

9. A portal structure according to any one of the preceding claims, characterized in that a presentation selection is a selection of “look and feel”.

10. A portal structure according to any one of the preceding claims, characterized in that the presentation characteristic files comprise CSS (Cascading Style Sheet) files.

11. A portal structure according to any one of the preceding claims, characterized in that the presentation control means establishes which are the presentation characteristics files to be used and/or which are the locations thereof based on end user/portal presentation selection in combination with the type of the end user station.

12. A portal structure according to claim 11, characterized in that location information relating to the location of presentation characteristics files (CSS-files) as given by end user/portal/application selections is added to the service/application data when received and read in the presentation arrangement.

13. A portal structure according to claim 12, characterized in that presentation characteristics file location information is introduced as one or more meta(location-information) link tags to the generic service/application data by the presentation control means.

14. A portal structure according to claim 13, characterized in that the rendering means translates and renders the generic data including the links to the appropriate presentation characteristics file(s) as determined by the control means.

15. A portal structure according to any one of the preceding claims, characterized in that the generic markup language is XML.

16. A portal structure at least according to claims 10 and 15, characterized in that the control means, based on end user presentation selection and portal and/or application presentation selection, if available, and end user station type determines a number of CSS files and in that for each such CSS file a metalink tag relating to the location of the respective CSS file is inserted into the application XML data and in that the XML data is translated into the end user station markup language with the CSS link(s) having the highest priority for each characteristic.

17. A presentation arrangement in a portal structure for handling presentation of services/applications requested by end user stations, comprising rendering means for rendering application/service data provided from requested services/applications for presentation on end user stations, characterized in that it further comprises reading means for reading service/application data received in a generic markup language from a service/application, first storing means for storing at least end user presentation selections relating to presentation characteristics, second storing means for storing presentation characteristics files, and presentation control means for controlling/managing the selection and implementation of the appropriate presentation characteristics file(s) for presentation of a requested service/application on an end user station.

18. A presentation arrangement according to claim 17, characterized in that for at least some services/applications portal and/or service/application presentation selections are provided.

19. A presentation arrangement according to claim 18, characterized in that an end user selection relating to a characteristic, if available, has a higher priority than a portal/service/application selection relating to the same characteristic, and thus is selected by the presentation control means for the characteristic in question.

20. A presentation arrangement according to any one of claims 17-19, characterized in that the presentation characteristics files comprise CSS (Cascading Style Sheet) files.

21. A presentation arrangement according to any one of claims 17-20, characterized in that location information relating to the location of presentation characteristics files (CSS-files) as given by end user/portal/application selections is added to the service/application data when received and read in the presentation arrangement.

22. A presentation arrangement according to any one of claims 17-21, characterized in that the type of the end user station is combined with end user/portal/application presentation selection to establish presentation characteristics file location information.

23. A presentation arrangement according to any one of claims 17-22, characterized in that the control means establishes which are the relevant presentation characteristics file(s) based on at least end user presentation selection and end user station type.

24. A presentation arrangement according to claim 23, characterized in that location information data relating to the relevant presentation characteristics file(s) (CSS-files) is/are introduced into the service/application data in the generic markup language as metalink tags before the service/application data is processed by the rendering means.

25. A presentation arrangement according to any one of claims 17-24, characterized in that the generic markup language is XML and in that the rendering means translates service/application XML data into the markup language understandable by a requesting end user station and inserts links to the appropriate presentation characteristics file(s).

26. A method of presenting a service/application requested by an end user station, via a portal structure, on the end user station, characterized in that it comprises the steps of:
storing at least end user presentation selections in first storing means,
storing a number of presentation characteristics files in second storing means,
receiving and reading data in a generic markup language from the requested service/application,
controlling selection of relevant presentation characteristic file(s) depending on end user presentation selection, portal presentation selection and application presentation selection, if available, and end user station type,
introducing a reference to the presentation characteristics file(s) into the service/application data in the generic markup language,
rendering the data in the generic markup language by translating it to the/a markup language understandable by the end user station including references to presentation characteristics file(s).

27. A method according to claim 26, characterized in that the generic markup language is XML and in that the presentation characteristics files comprise CSS-files.

28. A method according to claim 27, characterized in that it comprises the steps of:
introducing reference(s) in the form of (a) metalink tag(s) into the XML data,
performing the rendering translation step by means of an XSL Transformation Sheet selected in dependence on type of the end user station,
inserting the appropriate CSS-link(s) in the produced markup language.

29. A method according to any one of claims 26-28, characterized in that portal presentation selection(s) and/or application presentation selection(s) are available at least for some characteristics and in that a priority scheme is used for, determining which of the selections that is to be implemented in the rendering process for each characteristic.
